(19) United States
(12) Patent Application Publication
(10) Pub. No.: US 2009/0260040 A1
(43) Pub. Date: Oct. 15, 2009

(54) PROVIDING MULTIPLE TELEVISION CHANNEL PREVIEWING OF COMMERCIAL FREE CONTENT

(75) Inventors: Barry Alan Kritt, Raleigh, NC (US); Thomas S. Mazzeo, Durham, NC (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/102,386

(22) Filed: Apr. 14, 2008

(51) Int. Cl. H04N 5/445

(52) U.S. Cl. 725/56

(57) ABSTRACT

A system for capturing commercial free video samples. In response to receiving multiplexed channels input from a television service provider, channel preferences and general preferences are applied. A channel number is selected based on the channel preferences and general preferences. Channel guide information is collected for the selected channel number. It is determined whether a video sample for the selected channel number will complete before a program change based on the channel guide information. In response to determining that the video sample for the selected channel number will complete before a program change, a capture of a video sample from the selected channel number is started. A content of the capture of the video sample is analyzed for commercial content. Then, in response to determining that the content of the capture of the video sample does not include commercial content, the video sample is saved in a data buffer for use by an active icons display and control function upon viewer request.

### BACKGROUND OF THE INVENTION

1. Field of the Invention

The present invention relates generally to an improved data processing system and more specifically to a computer implemented method, system, and computer usable program code for providing multiple television channel previewing of commercial free content, which is collected using an automated surfing system.

2. Description of the Related Art

Today, most cable, satellite, and fiber optic television service providers have the ability to offer several hundred channels of programming for a viewer to select from. A recent study of television viewing in the United States and Canada indicates that 87% of households subscribe to some type of programming service, such as a cable, satellite, or fiber optic television programming service. In addition, the average household receives approximately 100 channels.

Many people with such television programming services like to surf the various channels to see what programs may be of interest for viewing. A viewer uses the remote control to change the channel, watches a few seconds of program content, and then decides to either stay on the same channel or change to the next channel. The viewer is generally able to decide whether to continue to watch a program based on the type of image that is displayed. Typically, the viewer watches the displayed image for a few seconds to see if the viewer recognizes the show based on the actors or the set or if the viewer is interested in the show based on the type of activity or theme being displayed, such as boats, hunting, game shows, comedy, drama, reality, et cetera.

As a result, surfing is an important part of television viewing nowadays. However, television surfing requires valuable viewing time because of the delays in changing from channel to channel, the large number of channels to surf, and commercial content being aired when the viewer is wanting to view program content.

### BRIEF SUMMARY OF THE INVENTION

According to one embodiment of the present invention, capturing of commercial free video samples is provided. In response to receiving multiplexed channels input from a television service provider, channel preferences and general preferences are applied. A channel number is selected for video sampling based on the channel preferences and general preferences. Channel guide information is collected for the selected channel number. It is determined whether a video sample for the selected channel number will complete before a program change based on the channel guide information. In response to determining that the video sample for the selected channel number will complete before a program change, a capture of a video sample from the selected channel number is started. A content of the capture of the video sample is analyzed for commercial content. Then, in response to determining that the content of the capture of the video sample does not include commercial content, the video sample is saved in a data buffer for use by an active icons display and control function upon viewer request.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is an exemplary illustration of a data processing system in accordance with an illustrative embodiment;

FIG. 4 is an exemplary illustration of channel sampling priority queues in accordance with an illustrative embodiment;

FIG. 5 is an exemplary illustration of a preference table in accordance with an illustrative embodiment; and

FIG. 6 is a flowchart illustrating an exemplary process for collecting commercial free video samples in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

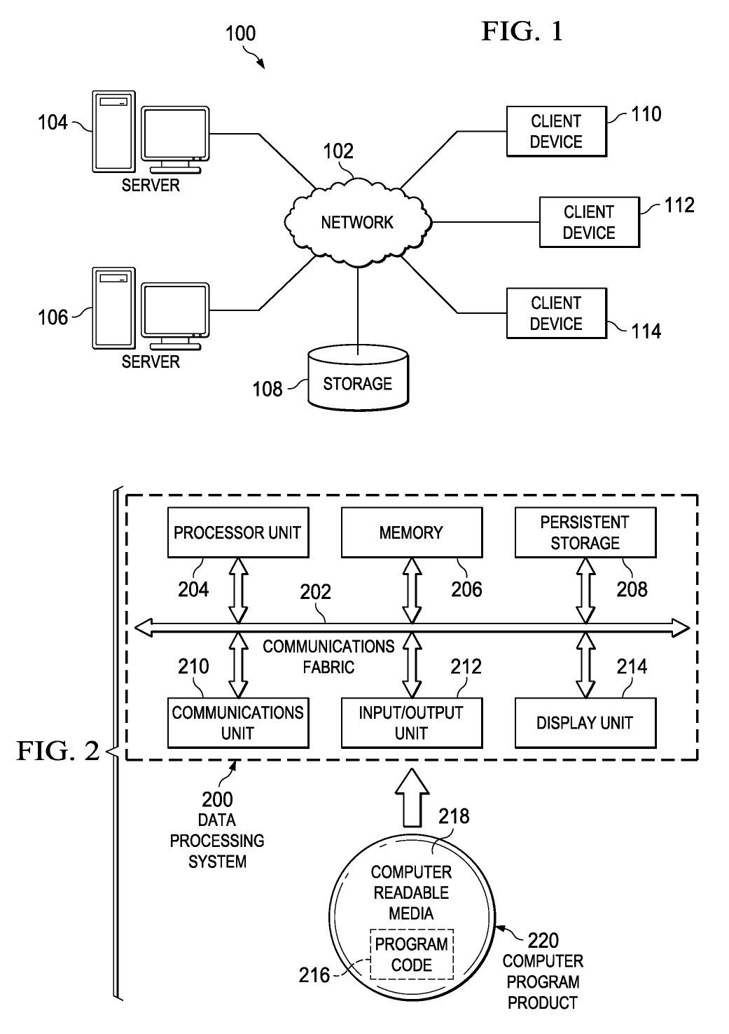

With reference now to the figures and in particular with reference to FIGS. 1-3, exemplary diagrams of data processing environments are provided in which illustrative embodiments may be implemented. It should be appreciated that FIGS. 1-3 are only exemplary and are not intended to assert or imply any limitation with regard to data processing environments in which different illustrative embodiments may be implemented. Many modifications to the depicted environments may be made.

FIG. 1 depicts a pictorial representation of a network of data processing systems in which illustrative embodiments may be implemented. Network data processing system 100 is a network of data processing systems, such as, for example, computers, television signal receivers, and other devices, in which the illustrative embodiments may be implemented. A television signal receiver may, for example, be a television set, itself, or a set-top box. A set-top box, such as a DSS box or cable box, is a device that connects to a television and an external source of signal, turning the signal into content, which is then displayed on a screen of a television.

Network data processing system 100 contains network 102. Network 102 is the medium used to provide communications links between the various devices connected together within network data processing system 100. Network 102 may include connections, such as wire, wireless communication links, or fiber optic cables.

In the depicted example, server 104 and server 106 connect to network 102, along with storage unit 108. Server 104 and server 106 represent television programming service providers, such as cable, satellite, and fiber optic television programming service providers. In addition, server 104 and server 106 may represent a network of computers and other devices necessary for these service providers to provide the television programming service.

Storage 108 represents any type of storage device that is capable of storing data in a structured or unstructured format. Also, storage 108 may represent a plurality of storage units coupled to network 102. Storage 108 may, for example, be a database that stores customer data and/or television programming data for a television programming service provider.

Further, client devices 110, 112, and 114 also connect to network 102. Client devices 110, 112, and 114 may be, for example, television receivers and personal computers. Client devices 110, 112, and 114 are clients to server 104 and/or server 106 in this example. Server 104 and server 106 provide data streams containing television programming content to client devices 110, 112, and 114. Furthermore, server 104 and server 106 may provide other data, such as boot files, operating system images, and applications to client devices 110, 112, and 114. Moreover, network data processing system 100 may include additional servers, clients, and other devices not shown.

Of course, network data processing system 100 may be implemented as a number of different types of networks, such as, for example, an intranet, a local area network (LAN), a wide area network (WAN), or the Internet. Also, is should be noted that FIG. 1 is only intended as an example and not as an architectural limitation for the different illustrative embodiments.

With reference now to FIG. 2, a block diagram of a data processing system is shown in which illustrative embodiments may be implemented. Data processing system 200 is an example of a computer, such as server 104 in FIG. 1, or a client device, such as client device 110 in FIG. 1, in which computer usable program code or instructions implementing the processes of the illustrative embodiments may be located. In this illustrative example, data processing system 200 includes communications fabric 202, which provides communications between processor unit 204, memory 206, persistent storage 208, communications unit 210, input/output (I/O) unit 212, and display unit 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory (RAM) or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208. In addition, persistent storage 208 may represent a plurality of persistent storage units.

Communications unit 210, in these examples, provides for communications with other data processing systems or devices, such as, for example, server 104 and server 106 in FIG. 1. In these examples, communications unit 210 is a network interface card. Communications unit 210 may provide communications through the use of either, or both, physical and wireless communications links.

Input/output unit 212 allows for input and output of data with other devices that may be connected to data processing system 200. For example, input/output unit 212 may provide a connection for user input through an alphanumeric keypad. Display unit 214 provides a mechanism to display information to a user of data processing system 200.

Instructions for the operating system and applications or programs are located on persistent storage 208. The operating system may, for example, be a Linux® operating system. An application may, for example, be television receiver software that includes programming selection and control logic.

The instructions for the operating system and applications or programs may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different illustrative embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different illustrative embodiments may be implemented. The different illustrative embodiments may be implemented in a data processing system including components in addition to, or in place of, those illustrated for data processing system 200. Other components shown in FIG. 2 may be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub, which may be present in communications fabric 202.

Illustrative embodiments provide a computer implemented method, system, and computer usable program code capturing commercial free video samples. In response to receiving multiplexed channels input from a television service provider, a television signal receiver applies channel preferences and general preferences. Then, the receiver selects a channel number for video sampling based on the channel preferences and general preferences. In addition, the receiver collects channel guide information, such as television program start and end times, for the selected channel number.

Subsequently, the receiver determines whether a video sample for the selected channel number will complete before a program change based on the channel guide information. In response to determining that the video sample for the selected channel number will complete before a program change, the receiver starts a capture of a video sample from the selected channel number. Then, the receiver analyzes a content of the capture of the video sample for commercial content. In response to determining that the content of the capture of the video sample does not include commercial content, the receiver saves the video sample in a data buffer for use by an active icons display and control function upon viewer request.

Illustrative embodiments utilize an unused tuner in, for example, a dual tuner television receiver, to do background sampling of all channels, or pre-selected subsets of channels, based on viewer input or on prior viewing habits of the viewer. Alternatively, illustrative embodiments may utilize a dedicated tuner in the television receiver to do the background sampling of the channels. Illustrative embodiments queue up several seconds, which the number of seconds may be selected by the viewer or may be based on the number of channels being buffered, of non-commercial content for each channel in a prioritized round robin manner. If the tuner encounters a commercial on a particular channel while progressing thru the channels, illustrative embodiments preserve the previously buffered content for that particular channel and give that channel a higher priority for subsequent re-sampling. In this way, illustrative embodiments always buffer the latest non-commercial content for each of the selected auto-surfing channels.

The auto-surfing system monitors program information in a channel guide schedule of programming to determine if the buffered content is still valid for a corresponding program on a channel. If the channel schedule indicates that a new program is being aired, illustrative embodiments discard the buffered content and that channel is given a higher priority for re-sampling. Illustrative embodiments display, upon viewer request, multiple channel surfing content, such as a 3×3 channel grid, which shows the buffered content for all of the channels in a continuous loop. The display may also include information on the thumbnails, such as channel number, show name, and show start/stop time.

Illustrative embodiments allow the viewer to select a channel displayed in the grid or to advance to the next grid that shows another set of channels. In an alternative embodiment, the channel guide may include the latest non-commercial content for a selected channel in the channel guide. When not being actively used, illustrative embodiments may employ all tuners for the auto-surfing system to increase the freshness and duration of the video sample thumbnails. Thus, illustrative embodiments allow a viewer to quickly surf thumbnails of many channels simultaneously, without commercial content. As a result, illustrative embodiments provide a more enjoyable surfing experience for the viewer.

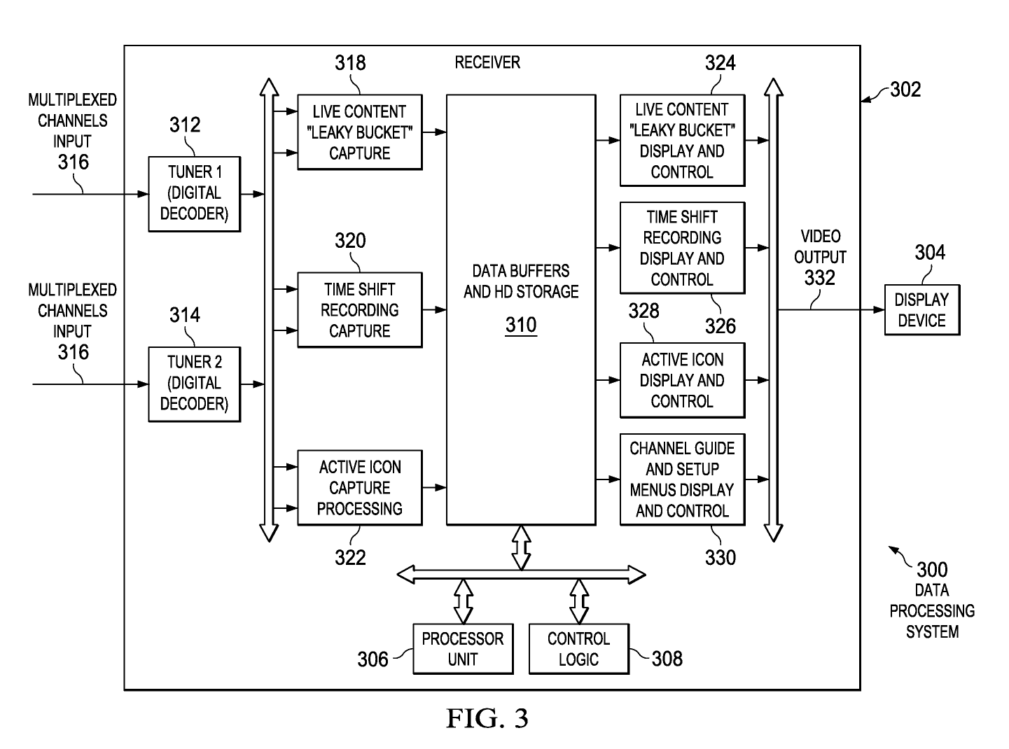

With reference now to FIG. 3, an exemplary illustration of a data processing system is depicted in accordance with an illustrative embodiment. Data processing system 300 may, for example, be data processing system 200 in FIG. 2. Data processing system 300 includes receiver 302 and display device 304. Receiver 302 and display device 304 may, for example, both be located within the same device, such as a television set. Alternatively, receiver 302 and display device 304 may be located in separate devices. For example, receiver 302 may be located in a set-top box, such as a cable box, and display device 304 may be located in the television set.

Receiver 302 is capable of receiving cable, satellite, or fiber optic television signals from television programming service providers. Receiver 302 includes processor unit 306, control logic 308, data buffers and hard drive (HD) storage 310, tuner 312, and tuner 314. Processor unit 306 may, for example, be processor unit 204 in FIG. 2. Processor unit 306 provides the processing capabilities for receiver 302. Control logic 308 may, for example, be computer program product 220 in FIG. 2. Control logic 308 provides the logic for controlling all the processes, such as a sample video capture process, in receiver 302. Data buffers and HD (Hard Drive) storage 310 may, for example, be memory 206 and persistent storage 208 in FIG. 2. Data buffers and HD storage 310 provide the data storage capabilities for receiver 302. The data buffers provide transient data storage for video samples of selected channel numbers. Illustrative embodiments may provide, for example, a 30 minute data buffer for each tuner. However, it should be noted that illustrative embodiments may provide more or less data buffer time for each tuner. The HD storage provides persistent storage of data.

Tuner 312 and tuner 314 receive multiplexed channels inputs 316. Multiplexed channels inputs 316 represent a plurality of incoming television channels, which are provided by one or more television programming services. Tuners 312 and 314 decode the incoming multiplexed channels signals to capture live content 318 for current viewing, capture time shift recording 320 for later viewing, and capture active icon processing 322 for display to a viewer upon request. Both tuner 312 and tuner 314 may perform any of these tasks.

Receiver 302 saves live content 318, time shift recording 320, and active icon processing 322 in data buffers and HD storage 310. Then, receiver 302 uses saved live content 318, time shift recording 320, and active icon processing 322 to output live content display and control 324, time shift recording display and control 326, and active icon display and control 328. In addition, receiver 302 outputs channel guide and setup menus display and control 330, which also may be included in multiplexed channels input 316.

Live content display and control 324, time shift recording display and control 326, active icon display and control 328, and channel guide and setup menus display and control 330 may be selected by control logic 308 to be routed to video output 332. Receiver 302 sends video output 332 to display device 304. Display device 304 displays video output 332 to the viewer. Display device 304 may, for example, be a screen in a television set or computer.

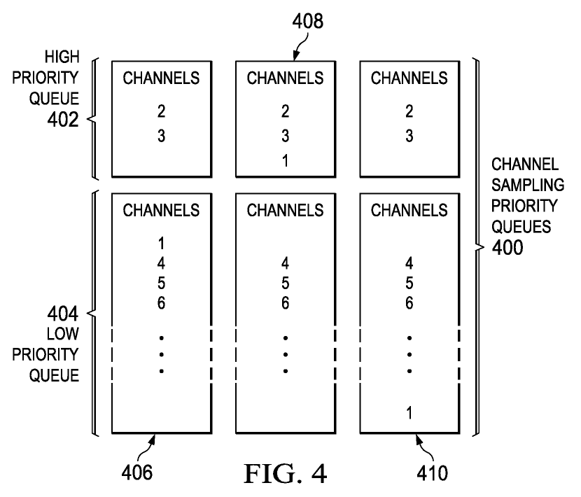

With reference now to FIG. 4, an exemplary illustration of channel sampling priority queues is depicted in accordance with an illustrative embodiment. Channel sampling priority queues 400 are a set of queues that prioritize all, or selected sub-sets of, channel numbers provided by a television programming service. Control logic in a television signal receiver, such as control logic 308 in FIG. 3, prioritizes the channel numbers based on user-defined and/or default preferences found in a preference table.

Channel sampling priority queues 400 includes high priority queue 402 and low priority queue 404. However, it should be noted that illustrative embodiments may utilize more or fewer channel sampling priority queues if desired or necessary. High priority queue 402 includes channel numbers that are set as high priority channels in the preference table. In this example, channel numbers 2 and 3 are set as high priority channels in the preference table and will remain in high priority queue 402 as long as channel numbers 2 and 3 are set as high priority channels. Low priority queue 404 includes channel numbers that are set as low priority channels in the preference table. In this example, channel numbers 1, 4, 5, and 6 are set as low priority channels in the preference table and appear in low priority queue 404. However, it should be noted that channel numbers, which appear low priority queue 404, may be placed in high priority queue 402 under certain conditions.

In general, the control logic samples the channel numbers in high priority queue 402 and low priority queue 404 by determining which queue to utilize based on the percentage (%) of sampling time specified in the preference table. For example, high priority queue 402 may be set at a 60% sampling time in the preference table and low priority queue 404 may be set at a 40% sampling time. In other words, the control logic samples channels in high priority queue 402 60% of the time and channels in low priority queue 404 40% of the time. The control logic samples the channel number with the oldest sample. In this example, the channel number with the oldest sample in the queue is the channel listed at the top of each queue.

Also in this example, assume the control logic samples channel number 1 in low priority queue 404 at block 406. Further assume, the control logic determines that commercial content is being aired while channel number 1 is being sampled. As a result, the control logic stops sampling channel number 1, preserves the previously buffered content for channel number 1, and places channel number 1 at the end of high priority queue 402 at block 408. After the control logic captures a non-commercial video sample for channel number 1, the control logic moves channel number 1 back to the end of low priority queue 404 at block 410.

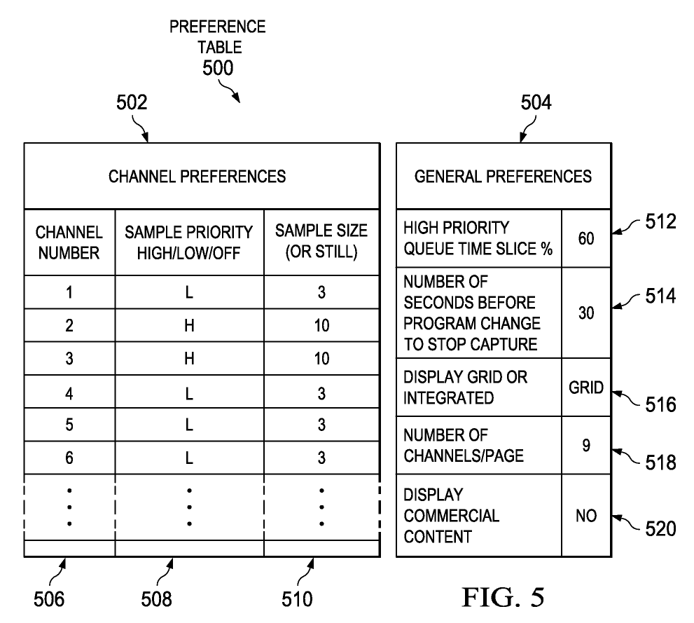

With reference now to FIG. 5, an exemplary illustration of a preference table is depicted in accordance with an illustrative embodiment. Preference table 500 is a table of user-defined and/or default preferences that are utilized by control logic in a television signal receiver, such as control logic 308 in FIG. 3, to capture and display commercial free video samples for all, or selected sub-sets of, channel numbers provided by a television programming service. Preference table 500 includes channel preferences 502 and general preferences 504.

Channel preferences 502 include channel number 506, sample priority 508, and sample size 510. Channel number 506 includes the numbers of channels that are to be sampled by the control logic in a prioritized round robin manner. Sample priority 508 includes the priority level setting, such as high, low, or off, for each corresponding channel number. Sample size 510 includes the size of the video sample in seconds. In this example, channel numbers 1, 4, 5, and 6 are set to a low priority level setting and will include a 3 second video sample size. Similarly, channel numbers 2 and 3 are set to a high priority level setting and will include a 10 second video sample size.

General preferences 506 include high priority queue time slice % 512, number of seconds before program change to stop capture 514, display grid or integrated 516, number of channels per page 518, and display commercial content 520. High priority queue time slice % 512 indicates the percentage of time the control logic is to sample channel numbers located in the high priority queue, such as high priority queue 402 in FIG. 4. In this example, high priority queue time slice % 512 is set to 60. In other words, the control logic will sample channel numbers in the high priority queue 60% of the time, compared to sampling channel numbers in the low priority queue, such as low priority queue 404 in FIG. 4, 40% of the time.

Number of seconds before program change to stop capture 514 indicates the amount of time before a program is scheduled to end in the program guide to stop the video sample capture process. In this example, number of seconds before program change to stop capture 514 is set to 30. In other words, the control logic will stop the capture of a video sample 30 seconds prior to a program's scheduled end.

Display grid or integrated 516 directs the control logic either to display a grid, such as a 3×3 grid, of video samples for selected channel numbers in a display device, such as a television screen, upon user request or to integrate a video sample for a user-selected channel number in the channel guide. Alternatively, the control logic may display, for example, video samples for 5 channels above and 5 channels below the user-selected channel number in the channel guide. In this example, display grid or integrated 516 is set to grid. Number of channels per page 518 limits the number of channels the control logic is to display per video sample page. In this example, number of channels per page 518 is set to 9. In other words, the control logic in this example will display 9 different video samples for selected channel numbers in a 3×3 grid. If multiple pages or grids of video samples are necessary, the control logic limits each page or grid to 9 total video samples.

Display commercial content 520 directs the control logic either to display commercial content in the video samples or not. In this example, display commercial content 520 is set to No. In other words, the control logic will not include commercial content in any displayed video sample.

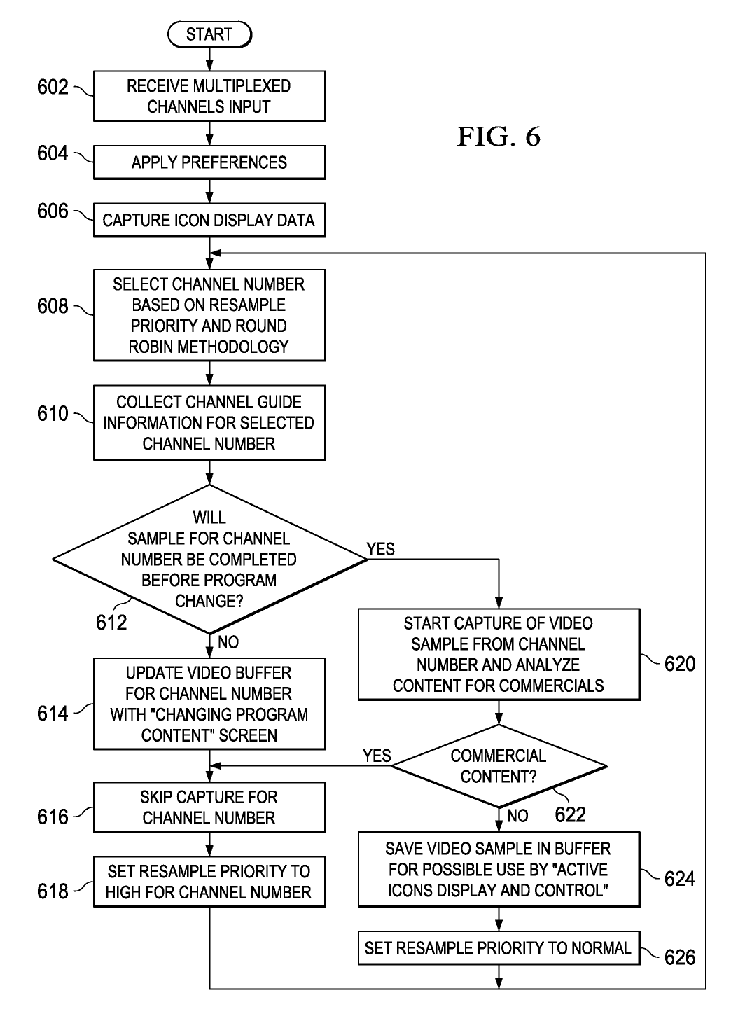

With reference now to FIG. 6, a flowchart illustrating an exemplary process for collecting commercial free video samples is shown in accordance with an illustrative embodiment. The process shown in FIG. 6 may be implemented in a receiver, such as receiver 302 in FIG. 3.

The process begins when the receiver receives multiplexed channels input, such as multiplexed channels inputs 316 in FIG. 3, from a television service provider, such as a cable, satellite, or fiber optic television service provider (step 602). Then, the receiver applies preferences, such as channel preferences 502 and general preferences 504 in preference table 500 in FIG. 5 (step 604). The preferences may be user-defined preferences, default preferences, or a combination of both.

Subsequently, the receiver captures icon display data based on the applied preferences (step 606). The receiver selects a channel number based on a resample priority and round robin methodology (step 608). Then, the receiver collects channel guide information for the selected channel number (step 610).

Afterward, the receiver makes a determination as to whether a video sample for the selected channel number will be completed before program change (step 612). If the video sample for the selected channel number will not be completed before program change, no output of step 612, then the receiver updates a video buffer, such as data buffers and HD storage 310 in FIG. 3, for the selected channel number with a screen display of, for example, “Changing Program Content” (step 614). Then, the receiver skips the capture of a video sample for the selected channel number (step 616). Subsequently, the receiver sets the resample priority to high for the selected channel number (step 618). Thereafter, the process returns to step 608 where the receiver selects another channel number.

Returning again to step 612, if the video sample for the selected channel number will be completed before program change, yes output of step 612, then the receiver starts the capture of the video sample from the selected channel number and analyzes the video sample content for commercial content (step 620). Afterward, the receiver makes a determination as to whether the video sample includes commercial content (step 622). If the video sample does include commercial content, yes output of step 622, then the process returns to step 616 where the receiver skips the video capture for the selected channel number. If the video sample does not include commercial content, no output of step 622, then the receiver saves the video sample in the video buffer for use by an active icons display and control, such as active icon display and control 328 in FIG. 3 (step 624). Then, the receiver sets the resample priority for the selected channel number to normal (step 626). Thereafter, the process returns to step 608 where the receiver selects another channel number.

Thus, illustrative embodiments of the present invention provide a computer implemented method, system, and computer program product for providing multiple television channel previewing of commercial free content, which is collected using an automated surfing system. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for capturing commercial free video samples, the computer implemented method comprising:
responsive to receiving multiplexed channels input from a television service provider, applying channel preferences and general preferences;
selecting a channel number for video sampling based on the channel preferences and general preferences to form a selected channel number;
collecting channel guide information for the selected channel number;
determining whether a video sample for the selected channel number will complete before a program change based on the channel guide information;
responsive to determining that the video sample for the selected channel number will complete before a program change, starting a capture of a video sample from the selected channel number;
analyzing a content of the capture of the video sample for commercial content; and
responsive to determining that the content of the capture of the video sample does not include commercial content, saving the video sample in a data buffer for use by an active icons display and control function upon viewer request.

2. The computer implemented method of claim 1, further comprising:
responsive to determining that the video sample for the selected channel number will not complete before the program change, skipping the capture of the video sample for the selected channel number; and
setting a resample priority for the selected channel number to high.

3. The computer implemented method of claim 1, further comprising:
responsive to determining that the content of the capture of the video sample does include commercial content, skipping the capture of the video sample for the selected channel number; and
setting a resample priority for the selected channel number to high.

4. A computer program product stored in a computer usable medium having computer usable program code embodied therein for capturing commercial free video samples, the computer program product comprising:
computer usable program code configured to apply channel preferences and general preferences in response to receiving multiplexed channels input from a television service provider;
computer usable program code configured to select a channel number for video sampling based on the channel preferences and general preferences to form a selected channel number;
computer usable program code configured to collect channel guide information for the selected channel number;
computer usable program code configured to determining whether a video sample for the selected channel number will complete before a program change based on the channel guide information;
computer usable program code configured to start a capture of a video sample from the selected channel number in response to determining that the video sample for the selected channel number will complete before a program change;
computer usable program code configured to analyze a content of the capture of the video sample for commercial content; and
computer usable program code configured to save the video sample in a data buffer for use by an active icons display and control function upon viewer request in response to determining that the content of the capture of the video sample does not include commercial content.

5. The computer program product of claim 4, further comprising:
computer usable program code configured to skip the capture of the video sample for the selected channel number in response to determining that the video sample for the selected channel number will not complete before the program change; and
computer usable program code configured to set a resample priority for the selected channel number to high.

6. The computer program product of claim 4, further comprising:
computer usable program code configured to skip the capture of the video sample for the selected channel number in response to determining that the content of the capture of the video sample does include commercial content; and
computer usable program code configured to set a resample priority for the selected channel number to high.
